(19) United States
(12) Patent Application Publication
(10) Pub. No.: US 2007/0194014 A1
(43) Pub. Date: Aug. 23, 2007

(54) Microwave oven and a base cover thereof

(76) Inventor: Eui-Seog Seig Jeong, Kyungsangnam-do (KR)

Correspondence Address: KED & ASSOCIATES, LLP, P.O. Box 221200, Chantilly, VA, 20153-1200, US

(21) Appl. No.: 10/575,859

(22) PCT Filed: Oct. 14, 2004
(86) PCT No.: PCT/KR04/02622

§ 371 Date: Feb. 28, 2007

(30) Foreign Application Priority Data
Oct. 16, 2003 (KR) 10-2003-0072130

(51) Int. Cl. H05B 6/64

(52) U.S. Cl. 219/757

(57) ABSTRACT

There is provided a base cover structure of a microwave oven, in which a reinforcement rib is formed at a periphery of an air intake hole of a stepped portion of a base cover in order to prevent the base cover from deformation. The air intake hole is also prevented from deformation, such that an outside air can be sucked at a constant rate, thereby cooling an electric component chamber without overheating.

### TECHNICAL FIELD

The present invention is related to a microwave oven and base cover of the microwave oven, and more particularly, to a microwave oven and base cover of the microwave oven, in which structure of a base cover is improved to have an enhanced strength.

### BACKGROUND ART

Generally, a microwave oven is a device that is used to heat food by radiating microwave generated from a magnetron to the food when electric current is applied to electric components of the device.

Such a microwave oven is classified into a household microwave oven having a small magnetron and a commercial microwave oven having a large (or a plurality of) magnetron.

The microwave oven is further classified according to a heating method into a glass tray method rotating the food and a stirrer fan method scattering microwave radiated into the cavity. The former is generally applied to the household microwave oven while the latter is applied to the commercial microwave oven.

Since the commercial microwave oven is generally used at convenience stores where the microwave oven is frequently used and restaurants where a large amount of the food should be quickly heated, the microwave oven needs relatively high power output compared with the household microwave oven.

The structure of the related art microwave oven will now be described.

A conventional microwave oven includes an outer case forming the exterior of the microwave oven, a cavity formed in the outer case to load food therein, a magnetron installed at one side of the cavity to generate a microwave, an electric component chamber accommodating various kinds of electric components such as a transformer, and a door for opening and closing an opening of the cavity.

The outer case includes an upper cover, a side cover, and a base cover to cover the top, side, and bottom of the cavity, respectively. The upper cover is spaced a predetermined distance apart from the top of the cavity. The base cover is bent upward at its periphery to form a stepped portion having a predetermined height and thereby the base cover is also spaced apart from the bottom of the cavity. A plurality of air intake holes are defined at a front part of the stepped portion of the base cover to allow an air inflow. The air sucked through the air intake holes is directed to the space formed by the stepped portion between the base cover and the bottom of the cavity.

Further, an air filter is installed on a front of the air intake holes to prevent foreign particles contained in the inflow air from entering the microwave oven.

However, the base cover having the air intake holes according to the related art has the following problems.

When a blower fan installed in the electric component chamber is driven, an outside air is directed into the microwave oven through air intake holes formed in the stepped portion of the base cover. Since the stepped portion supports the cavity and the electric component chamber that are located above the base cover, a lasting load deforms the air intake holes and as well the stepped portion. This deformation causes the microwave oven to incline to one side, and the inclination of the microwave oven causes improper cooking of the food loaded in the cavity.

Further, the deformation of the stepped portion may decrease the sizes of the air intake holes to cause decrease of airflow rate. Therefore, the electric component chamber cannot be cooled sufficiently and thereby the microwave oven will operate abnormally.

### DISCLOSURE OF THE INVENTION

### Technical Problem

Accordingly, the present invention is directed to a microwave oven and base cover thereof that substantially obviates one or more of the problems due to limitations and disadvantages of the related art.

An object of the present invention is to provide a base cover structure, in which an air intake hole defined in a stepped portion of a base cover is designed to have improved structure and thereby the base cover supporting a cavity and various kinds of electric components can enhance its strength.

Another object of the present invention is to provide a base cover structure that allows sufficient air inflow through an air intake hole toward the inside of a microwave oven.

### TECHNICAL SOLUTION

To achieve these and other advantages and in accordance with the purpose of the present invention, as embodied and broadly described, there is provided a microwave oven including: a cavity in which food is cooked and a base cover having: a cover body installed under the cavity and contacting a mounting surface, a stepped portion bent upward from an end of the cover body for supporting the cavity, at least one air intake hole defined in the stepped portion for sucking an outside air, and a reinforcement rib protruded forwardly and/or backwardly from a periphery of the air intake hole.

In another aspect of the present invention, there is provided a microwave oven including: a cavity for accommodating food for cooking; a control panel for inputting a cooking condition; a cover body installed under the cavity; a front stepped portion bent upward from a font end of the cover body; an air intake hole having at least one cavity intake hole defined in the front-stepped portion to allow an air inflow under the cavity and at least one panel intake hole to allow an air inflow under the control panel; and a reinforcement member formed at a periphery of the air intake hole.

In a further another aspect of the present invention, there is provided a base cover structure of a microwave oven, including: a cover body installed under a cavity, the cover body being spaced a predetermined distance apart from a bottom of the cavity; a stepped portion bent from an end of the base cover; at least one air intake hole defined in the stepped portion to allow an air inflow; a reinforcement rib formed by cutting and bending a part of the stepped portion to enhance the strength of the stepped portion and to prevent the air intake hole from deformation.

In a still further another aspect of the present invention, there is provided a microwave oven including: a cavity; and a base cover having: a stepped portion bent upwardly from a bottom, of the cover body for supporting the cavity, a cavity intake hole defined in the stepped portion that is disposed under the cavity, a panel intake hole defined beside the cavity intake hole with a size smaller than the cavity intake hole, and a reinforcement member protruded from a periphery of the cavity intake hole and/or from a periphery of the panel intake hole.

### ADVANTAGEOUS EFFECTS

A base cover structure and microwave oven having the same, having the above-mentioned construction according to the present invention, provides more reliable supporting for a cavity and electric components by enhancing the strength of the base cover.

Further, a reinforcement structure is applied around an air intake hole to prevent the air intake hole from deformation, and thereby a stepped portion where the air intake hole is defined can securely support a cavity of microwave oven without deformation.

Furthermore, there is no deformation of an air intake hole defined at a front stepped portion of a base cover, such that an indoor air can be sucked at a constant rate through the air intake hole toward an inside of a microwave oven and thereby electric components in an electric component chamber can be cooled properly.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exploded perspective view of a microwave oven provided with a base cover structure according to the present invention.

FIG. 2 is a partial perspective view showing a front of a base cover according to the present invention.

FIG. 3 is a partial perspective view showing a rear of a front stepped portion of a base cover according to the present invention.

### BEST MODE

Reference will now be made in detail to the preferred embodiments of the present invention, examples of which are illustrated in the accompanying drawings. It will be apparent to those skilled in the art that various modifications and variations can be made in the present invention. Thus, it is intended that the present invention covers the modifications and variations of this invention provided they come within the scope of the appended claims and their equivalents.

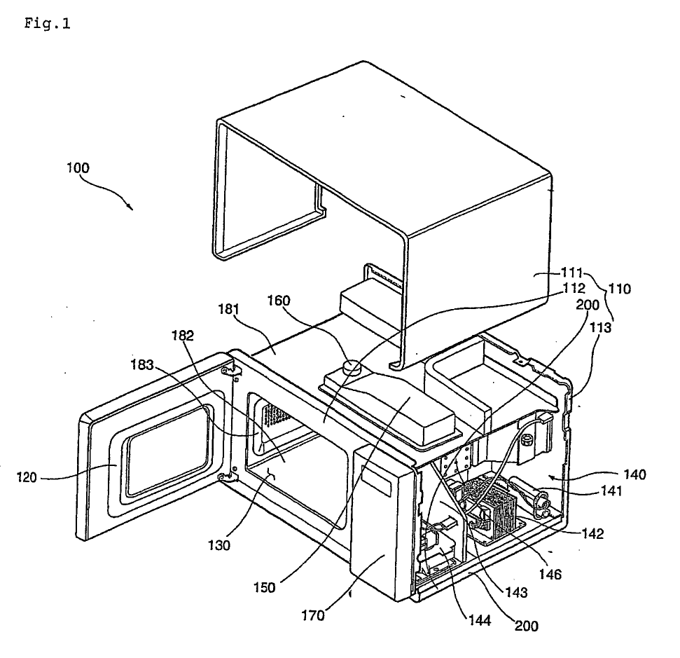

FIG. 1 is an exploded perspective view of a microwave oven provided with a base cover structure according to the present invention.

Referring to FIG. 1, a microwave oven 100, provided with a base cover structure, includes an outer case 110 forming the exterior, an electrical component chamber 140 protected by the outer case 110 and mounted with a plurality of electrical components, a cavity 130 to which food is to be accommodated for cooking, an upper duct (not shown) installed above the cavity 130, and a door 120 installed at a front of the cavity 130.

The outer case 110 forms the exterior of the microwave oven 100 and protects the cavity 130 located therein. The outer case 110 may be made of an iron plate that has a desired strength.

In detail, the outer case 110 includes parts installed around the cavity 130: an upper cover 111 to cover the top and each side of the cavity 130; a base cover 200 to protect the bottom of the cavity 130; a front cover 112 to form the front of the cavity 130; and a back cover 113 to protect the rear of the cavity 130. A door 120 is installed at the front of the front cover 112, and a control panel 170 is provided beside the door 120, the control panel 170 being provided with a plurality of buttons for inputting operational conditions of the microwave oven 100. Since the base cover 200 protects the bottom of the cavity 130 and also supports the cavity 130 and various kinds of electrical components, the base cover 200 may be made of an iron plate having a desired strength. A bottom surface of the base cover 200 is spaced a predetermined distance apart from the bottom of the cavity 130. The base cover 200 will be described more fully with respect to the accompanying drawings.

The cavity 130 is a place where food is cooked. The cavity 130 has a box-like shape with a front opening. Food is inserted and took out through the opening before and after cooking. The door 120 opens and closes the opening.

The cavity 130 is formed by the combination of an upper plate 181, a side plate 183, a lower plate 182, and a rear plate (not shown). The upper plate 181 is provided at an upper outer side with a waveguide 150 for guiding a microwave produced by a magnetron to the cavity 130. A synchronous motor 160 is mounted on one side of the waveguide 150 for driving a stirrer fan. The stirrer fan (not shown) is mounted between the upper plate 181 and the upper duct, the upper duct being installed under the upper plate 181.

The waveguide 150 is also installed at lower outer side of the cavity 130 besides the upper outer side of the upper plate 181, such that the microwave can be directed to the cavity 130 in downward and upward directions.

The electric component chamber 140 is located at a right or left portion inside the outer case 110 to accommodate a plurality of electrical components.

The plurality of electrical components includes a magnetron 146 generating a microwave, a transformer 142 converting low voltage to high voltage for applying high voltage to the magnetron 146, a blower fan 144 blowing away an warm air heated by the plurality of electrical components during the generation of the microwave, and a capacitor 141 storing an electric charge for the transformer 142.

A vertical barrier 143 divides the electric component chamber 140 into two-portions to separate the transformer 142 and the blower fan 144. The transformer 142, the blower fan 144, the capacitor 141, and the barrier 143 are fixed on a sub plate. The sub plate is spaced apart from the base cover 200 in an upward direction.

In detail, the transformer 142 and the magnetron 146 are used to generate the microwave in the cavity 130. During the generation of the microwave for cooking, a heat is also generated from the electric components and thereby the temperature of the cavity 130 increases.

For cooling the cavity 130, the blower fan 144 sucks outer air and blows the air to the hot electrical components.

The operation of the microwave oven 100, having above-mentioned elements, will now be described.

The door 120 is opened to place food into the cavity 130, the door 120 is closed and cooking conditions such as heating time are set using the buttons of the control panel 170. After that, by pressing a start button, the electrical components of the electric component chamber 140 are powered on, and the magnetron 146 generates a microwave. The generated microwave is directed into the cavity 130 through the waveguide 150. The microwave directed into the cavity 130 is reflected throughout the cavity 130 by the stirrer fan installed upper and lower side of the cavity 130, thereby evenly heating the food.

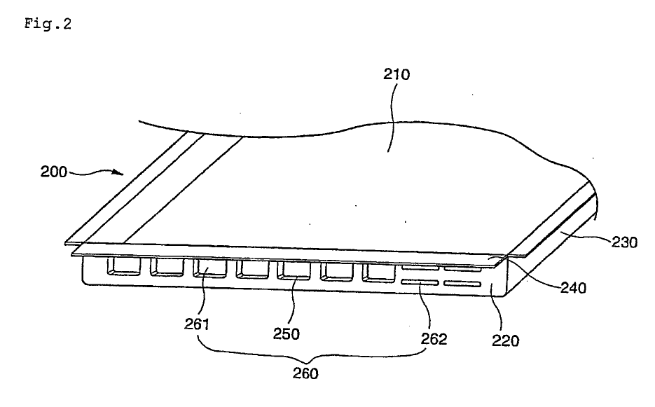

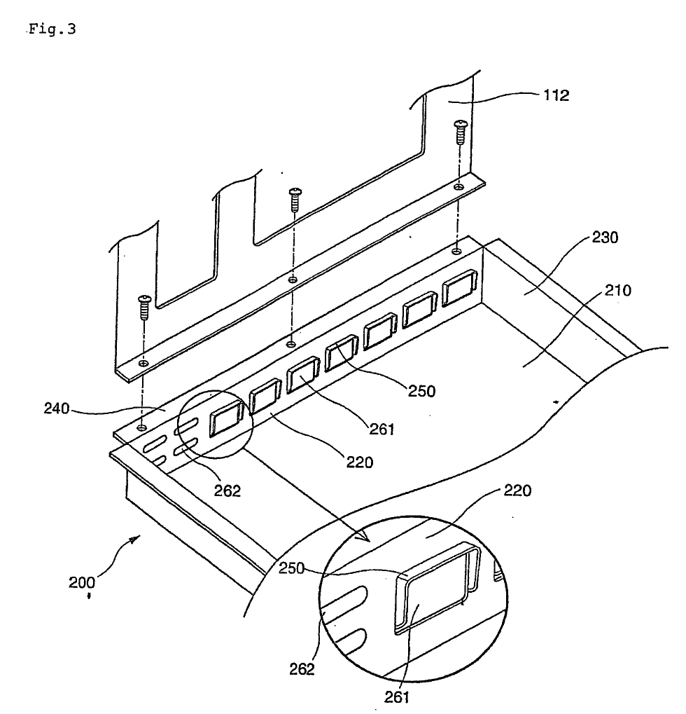

FIG. 2 is a partial perspective view showing a front of a base cover according to the present invention, and FIG. 3 is a partial perspective view showing a rear of a front stepped portion of a base cover according to the present invention.

Referring to FIGS. 2 and 3, the base cover 200 includes a cover body 210, a front stepped portion 220 bent upwardly at a front end of the cover body 210 with a predetermined height, side stepped portions 230, and a rear stepped portion (not shown).

The cover body 210 forms a bottom of the base cover 200 to protect a lower side of the cavity 130 and to form a bottom of the electric component chamber 140.

The front stepped portion 220 is secondly bent forwardly at its end to form an extended portion 240. The front cover 112 is fixed to the extended portion 240, and a front lower side of the cavity 130 is accommodated and supported by the extended portion 240.

The front stepped portion 220 includes a plurality of air intake holes 260. The air intake hole 260 can also be formed in the side stepped portions 230 and/or the rear stepped portion.

The air intake hole 260 includes cavity intake holes 261 defined under the cavity 130, and panel intake holes 262 defined under the control panel 170. In other words, the cavity intake holes 261 are defined through the front stepped portion 220, and the panel intake holes 262 are defined at a right side of the cavity intake holes 261 when viewed from the front (refer to FIG. 2).

The sizes of the panel intake holes 262 are smaller than those of the cavity intake holes 261 to prevent users from inserting fingers, sticks or the like into the electric component chamber 140, thereby protecting the user from electricity during the operation of microwave oven 100.

Reinforcement ribs 250 are provided at a rear surface of the front stepped portion 220 to enhance the strength of the front stepped portion 220 and to prevent deformation of the air intake holes 260.

In detail, the reinforcement ribs 250 are protruded 0 backwardly from peripheries of the cavity intake holes 261, and each of the reinforcement ribs 250 is formed into “τ”-like shape surrounding a top and each side of the cavity intake hole 261. Also, the reinforcement ribs 250 can be protruded forwardly from the peripheries of the cavity intake holes 261. In addition, the reinforcement ribs 250 can be formed around the panel intake holes 262.

The reinforcement ribs 250, bent from the front stepped portion 220, are integrally formed with the front stepped portion 220.

As described above, the reinforcement ribs 250 are formed at the rear surface of the front stepped portion 220 to enhance the strength of the front stepped portion 220, thereby preventing the air intake holes 260 from deformation.

The process of forming the reinforcement ribs 250 at the rear surface of the front stepped portion 220 will now be described.

The base cover 200 is made of an iron plate by using a blanking process. At the same blanking process is also formed the air intake holes 260. The front stepped portion 220 and the side stepped portions 230 are also bent during the blanking process. In this manner, the base cover 200 is provided with the front stepped portion 220 having the air intake holes 260 and the side stepped portions 230. Herein, the air intake holes 260 can be formed using a separate process after the front stepped portion 220 and the side stepped portions 230 are formed.

Though the process of forming the base cover 200 is described above, the front stepped portion 220, the side stepped portions 230, and the air intake holes 260 of the base cover 200 may be formed using another process or different procedure according to choice of designer or manufacturer's convenience.

The processes of forming the reinforcement ribs 250, protruded backwardly from the peripheries of the cavity intake holes 261, will not be described.

The front stepped portion 220 and the cavity intake holes 261 are formed through bending and punching processes with selected sizes and directions by adjusting the bending/punching press and die.

When using the die to process the iron plate, the die normally includes an upper die and a lower die, between which the iron plate is inserted for the bending and punching.

In detail, the iron plate is placed on the lower die and the press makes the upper die strike the iron plate to make the base cover 200 to have the air intake holes 260. Herein, the lower die forms the air intake holes 260 and at the same time bends peripheries of the cavity intake holes 261 upwardly to form the protruded reinforcement ribs 250. After that, a portion, in which the air intake holes 260 are formed, is bent upwardly to form the front stepped portion 220, such that the base cover 200 can have the air intake holes 260 and the reinforcement ribs 250 at its frost stepped portion 220. According to the above processes, the reinforcement ribs 250 are directed to protrude in the rear direction of the front stepped portion 220.

The above-mentioned processes are exemplary illustrated. The processes can be changed according to manufacturing equipment and convenience in design.

### INDUSTRIAL APPLICABILITY

A base cover of microwave oven is provided with reinforcement ribs that are formed around air intake holes of a front stepped portion according to the present invention, such that the base cover can support the microwave oven more securely and the air intake holes can be reliably protected from deformation, thereby increasing industrial applicability.

1. A microwave oven comprising:
a cavity in which food is cooked; and
a base cover having:
a cover body installed under the cavity and contacting a mounting surface,
a stepped portion bent upward from an end of the cover body for supporting the cavity,
at least one air intake hole defined in the stepped portion for sucking an outside air, and
a reinforcement rib protruded forwardly and/or backwardly from a periphery of the air intake hole.

2. The microwave oven according to claim 1, wherein the stepped portion is bent upwardly from a front end of the cover body with a predetermined height.

3. The microwave oven according to claim 1, wherein the stepped portion is bent upwardly from a side end of the cover body with a predetermined height.

4. The microwave oven according to claim 1, wherein the air intake hole includes a cavity intake hole defined under the cavity and a panel intake hole defined beside the cavity intake hole.

5. The microwave oven according to claim 4, wherein the size of the cavity intake hole is larger than or at least equal to that of the panel intake hole.

6. The microwave oven according to claim 1, wherein the reinforcement rib is formed at an upper periphery and a side periphery of the air intake hole.

7. The microwave oven according to claim 1, wherein the reinforcement rib has a “τ”-shaped section.

8. The microwave oven according to claim 1, wherein the reinforcement rib is formed by cutting and bending a part of the stepped portion, such that the reinforcement rib is protruded forwardly or backwardly from the periphery of the air intake hole.

9. The microwave oven according to claim 1, wherein the reinforcement rib is integrally formed with the stepped portion.

10. A microwave oven comprising:
a cavity for accommodating food for cooking;
a control panel for inputting a cooking condition;
a cover body installed under the cavity;
a front stepped portion bent upward from a font end of the cover body;
an air intake hole having at least one cavity intake hole defined in the front stepped portion to allow an air inflow under the cavity and at least one panel intake hole to allow an air inflow under the control panel; and
a reinforcement member formed at a periphery of the air intake hole.

11. The microwave oven according to claim 10, wherein the reinforcement member is a reinforcement rib protruded forwardly or backwardly from the periphery of the air intake hole.

12. The microwave oven according to claim 10, wherein the size of the panel intake hole is smaller than that of the cavity intake hole in order to prevent an insertion of user's body part.

13. The microwave oven according to claim 10, wherein the reinforcement member is formed by cutting and bending a part of the front stepped portion.

14. The microwave oven according to claim 10, further comprising an extended portion bent from a top end of the front stepped portion at a predetermined angle, the extended portion being mounted under the cavity.

15. The microwave oven according to claim 10, wherein the reinforcement member is integrally formed along a top periphery and a side periphery of the air intake hole.

16. A base cover structure of a microwave oven, comprising:
a cover body installed under a cavity, the cover body being spaced a predetermined distance apart from a bottom of the cavity;
a stepped portion bent from an end of the base cover;
at least one air intake hole defined in the stepped portion to allow an air inflow;
a reinforcement rib formed by cutting and bending a part of the stepped portion to enhance the strength of the stepped portion and to prevent the air intake hole from deformation.

17. The base cover structure according to claim 16, wherein the reinforcement rib is protruded forwardly from a periphery of the intake hole.

18. The base cover structure according to claim 16, wherein the reinforcement rib is protruded backwardly from a periphery of the intake hole.

19. The base cover structure according to claim 16, wherein the stepped portion is a front stepped portion formed at a front of the cover body.

20. A microwave oven comprising:
a cavity; and
a base cover having:,
a stepped portion bent upwardly from a bottom of the cover body for supporting the cavity,
a cavity intake hole defined in the stepped portion that is disposed under the cavity,
a panel intake hole defined beside the cavity intake hole with a size smaller than the cavity intake hole, and
a reinforcement member protruded from a periphery of the cavity intake hole and/or from a periphery of the panel intake hole.
